(19) United States
(12) Patent Application Publication
(10) Pub. No.: US 2017/0006078 A1
(43) Pub. Date: Jan. 5, 2017

(54) METHODS AND APPARATUS FOR CODEC NEGOTIATION IN DECENTRALIZED MULTIMEDIA CONFERENCES

(71) Applicant: QUALCOMM Incorporated, San Diego, CA (US)

(72) Inventors: Nikolai Konrad Leung, San Francisco, CA (US); Venkatraman Atti, San Diego, CA (US); Ye-Kul Wang, San Diego, CA (US)

(21) Appl. No.: 15/187,654

(22) Filed: Jun. 20, 2016

Related U.S. Application Data
(60) Provisional application No. 62/187,197, filed on Jun. 30, 2015.
(60) Provisional application No. 62/200,467, filed on Aug. 3, 2015.
(60) Provisional application No. 62/206,782, filed on Aug. 18, 2015.
(60) Provisional application No. 62/236,687, filed on Oct. 2, 2015.

(51) Int. Cl. H04L 29/06; H04M 7/00

(52) U.S. Cl. CPC H04L 65/601; H04M 7/0072; H04L 65/1069; H04L 65/403

(57) ABSTRACT

Methods and apparatus are disclosed for codec negotiation in a decentralized conference. In one aspect, a method for codec negotiation in a decentralized conference is provided. The method includes transmitting, from a first device, an offer message to two or more devices for establishing a conference, the offer message including a list of codec capabilities supported by the first device. The method further includes receiving, at the first device, a response message from each of the two or more devices, the response message including a codec type selected from the list of codec capabilities supported by the first device and including a list of codec capabilities supported by a device of the two or more devices. The method further includes determining, at the first device, whether each of the two or more devices can continue to participate in the conference based on the list of codec capabilities in each of the response messages.

### CROSS REFERENCE TO RELATED APPLICATIONS

This application claims priority benefit under 35 U.S.C. §119(e) to U.S. Provisional Patent Application No. 62/187,197 entitled “METHODS AND APPARATUS FOR CODEC NEGOTIATION IN DECENTRALIZED MULTIMEDIA CONFERENCES” filed on Jun. 30, 2015, U.S. Provisional Patent Application No. 62/200,467 entitled “METHODS AND APPARATUS FOR CODEC NEGOTIATION IN DECENTRALIZED MULTIMEDIA CONFERENCES” filed on Aug. 3, 2015, U.S. Provisional Patent Application No. 62/206,782 entitled “METHODS AND APPARATUS FOR CODEC NEGOTIATION IN DECENTRALIZED MULTIMEDIA CONFERENCES” filed on Aug. 18, 2015, and U.S. Provisional Patent Application No. 62/236,687 entitled “METHODS AND APPARATUS FOR CODEC NEGOTIATION IN DECENTRALIZED MULTIMEDIA CONFERENCES” filed on Oct. 2, 2015, the disclosure of each is hereby incorporated by reference in its entirety.

### FIELD

This disclosure relates to the field of codec negotiation, and particularly to codec negotiation in decentralized multimedia conferences.

### BACKGROUND

Digital video and audio capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video and audio devices implement video and audio compression techniques, such as those described in the standards defined by Moving Picture Experts Group-2 (MPEG-2), MPEG-4, International Telegraph Union-Telecommunication Standardization Sector (ITU-T) H.263, ITU-T H.264/MPEG-4, Part 10, Advanced Video Coding (AVC), the High Efficiency Video Coding (HEVC) standard, and extensions of such standards. The video and audio devices may transmit, receive, encode, decode, and/or store digital video and audio information more efficiently by implementing such video and audio coding techniques.

Video and audio coding standards, such as Scalable HEVC (SHVC) and Multiview HEVC (MV-HEVC), provide level definitions for defining decoder capability. In the following, the issues and solutions are described based on the existing level definition and other contexts of SHVC at the time when the invention was made, but the solutions apply to MV-HEVC, and other multi-layer codecs as well.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described in the disclosure provides a method for codec negotiation in a conference. The method comprises retrieving a list of codec capabilities supported by each of two or more devices in the conference and determining, at a first device, whether each of the two or more devices can participate in the conference based on the list of codec capabilities.

Another aspect of the disclosure is a method for codec negotiation in a conference. The method comprises receiving, from a first device, an offer message for establishing a conference, the offer message including a list of codec capabilities for the conference and selectively transmitting, at a second device, a first message, the first message including a codec type selected from the list of codec capabilities for the conference.

Another aspect of the disclosure is a method for codec negotiation in a conference. The method comprises transmitting, from a first device, an offer message to two or more devices for establishing a conference, the offer message including a list of codec capabilities for the conference, receiving, at the first device, a first message from each of the two or more devices, the first message including a codec type selected from the list of codec capabilities for the conference, determining, at the first device, whether each of the two or more devices can participate in the conference based on the list of codec capabilities for the conference, selectively transmitting, at the first device, a data stream to a second device of the two or more devices based on the list of codec capabilities for the conference, receiving a second message, at the first device, requesting that the data stream be transmitted to a third device, and transmitting the data stream to the third device. Further aspects may comprise transmitting, from the first device, a second offer message based on the list of codec capabilities in the first when the first device determines a device of the two or more devices cannot continue to participate in the conference. Further aspects may comprise storing the list of codec capabilities supported by each of the two or more devices in a database. Further aspects may comprise prioritizing a data stream based on a parameter of the data stream. Further aspects may comprise wherein the parameter comprises one or more of a volume level, a complexity level, an activity level, a device or data stream identification (ID) and a data packet size. Further aspects may comprise wherein the list of codec capabilities in the offer message comprises one or more of an indication of codec capabilities per codec, an indication of codec capabilities for the encoder and decoder of each codec, an indication of whether concurrent operation of an encoder and/or decoder of different codecs share the same computational resource, and an indication that a device of the two or more devices is capable of reducing the number of received data streams to match its concurrent decoding capabilities such that the decoding capabilities of the device do not impose a constraint on the number of conference participants.

Another aspect of the disclosure is an apparatus for communicating in a conference. The apparatus comprises a receiver configured to receive a request message for establishing the conference, the request message requesting a list of codec capabilities supported by the apparatus and a transmitter configured to selectively transmit a response message, the response message including a list of codec capabilities supported by the apparatus.

Another aspect of the disclosure is an apparatus for communicating in a conference. The apparatus comprises a transmitter configured to transmit a request message to two or more devices for establishing a conference, the request message requesting a list of codec capabilities supported by one of the two or more devices, a receiver configured to receive a response message from each of the two or more devices, the response message including a list of codec capabilities supported by one of the two or more devices, and a processor configured to determine whether each of the two or more devices is capable of participating in the conference based on the list of codec capabilities in each of the response messages.

Another aspect of the disclosure is an apparatus for communicating in a decentralized conference. The apparatus comprises means for receiving, at a first device, a request message for establishing a conference, the request message requesting a list of codec capabilities supported by the first device and means for selectively transmitting, at the first device, a response message, the response message including the list of codec capabilities supported by the first device.

Another aspect of the disclosure is an apparatus for communicating in a decentralized conference. The apparatus comprises means for transmitting, from a first device, a request message to two or more devices for establishing a conference, the request message requesting a list of codec capabilities supported by one of the two or more devices, means for receiving, at the first device, a response message from each of the two or more devices, the response message including a list of codec capabilities supported by one of the two or more devices, and means for determining, at the first device, whether each of the two or more devices is capable of participating in the conference based on the list of codec capabilities in each of the response messages.

Another aspect of the disclosure is a non-transitory computer readable storage medium having stored thereon instructions that, when executed, cause a processor to perform a method. The method comprises receiving, at a first device, a request message for establishing a conference, the request message requesting a list of codec capabilities supported by the first device and selectively transmitting, at the first device, a response message, the response message including the list of codec capabilities supported by the first device.

Another aspect of the disclosure is a non-transitory computer readable storage medium having stored thereon instructions that, when executed, cause a processor to perform a method. The method comprises transmitting, from a first device, a request message to two or more devices for establishing a conference, the request message including a list of codec capabilities supported by one of the two or more devices, receiving, at the first device, a response message from each of the two or more devices, the response message including a list of codec capabilities supported by one of the two or more devices and determining, at the first device, whether each of the two or more devices is capable of participating in the conference based on the list of codec capabilities in each of the response messages.

### BRIEF DESCRIPTION OF THE DRAWINGS

FIG. 1 illustrates an example of a conference architecture for multiple participants.

FIG. 2 illustrates an example of a decentralized conference architecture for multiple participants.

FIG. 3 illustrates another example of a decentralized conference architecture for multiple participants.

FIG. 4 illustrates an example of a hybrid conference architecture for multiple participants where a terminal functions as a mixer.

FIG. 5 illustrates an example of a hybrid conference architecture for multiple participants where a terminal functions as a mixer and participant.

FIG. 6 is flowchart of an exemplary method for codec negotiation in a decentralized conference.

FIG. 7 is flowchart of another exemplary method for codec negotiation in a decentralized conference.

FIG. 8 is flowchart of an exemplary method for codec negotiation in a conference.

FIG. 9 is flowchart of another exemplary method for codec negotiation in a conference.

### DETAILED DESCRIPTION

The detailed description set forth below in connection with the appended drawings is intended as a description of certain implementations of the invention and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the disclosed implementations. In some instances, some devices are shown in block diagram form.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

In addition, a video coding standard, namely High Efficiency Video Coding (HEVC), has been developed by the Joint Collaboration Team on Video Coding (JCT-VC) of ITU-T Video Coding Experts Group (VCEG) and ISO/IEC MPEG. The full citation for the HEVC Draft 10 is document JCTVC-L1003, Bross et al., “High Efficiency Video Coding (HEVC) Text Specification Draft 10,” Joint Collaborative Team on Video Coding (JCT-VC) of ITU-T SG16 WP3 and ISO/IEC JTC1/SC29/WG11, 12th Meeting: Geneva, Switzerland, Jan. 14, 2013 to Jan. 23, 2013. The multiview extension to HEVC, namely MV-HEVC, and the scalable extension to HEVC, named SHVC, are also being developed by the JCT-3V (ITU-T/ISO/IEC Joint Collaborative Team on 3D Video Coding Extension Development) and JCT-VC, respectively. A recent Working Draft (WD) of MV-HEVC will be referred to hereinafter as MV-HEVC WD7. A recent WD of SHVC will be referred to hereinafter as SHVC WD5.

Existing approaches to level definitions sometimes do not provide sufficient information to define decoder capabilities for efficient decoding of multi-layer bitstreams. For example, to decode more than 4 signal-to-noise ratio (SNR) scalable layers (layers having equivalent resolution) of 720p resolution each, a Level 5 decoder or above would be required. Consequently, the luminance coding tree block (CTB) size would be equal to 32×32 or 64×64 (i.e., smaller coding sizes such as 16×16 cannot be used). However, for some layers, such as those having resolutions of 720p or lower, this restriction may result in sub-optimal coding efficiency

Decoders may be manufactured in some instances by reusing multiple existing single-layer decoders. In an example, an SHVC decoder consisting of 4 single-layer HEVC Level 3.1 decoders would have to conform to Level 4 or above to decode 4 SNR layers of 720p, per the existing level definition. By this definition, the decoder would have to be able to decode any Level 4 bitstreams. However, barring changes to the decoder hardware, such a decoder would not be able to decode an SHVC Level 4 bitstream with 2 SNR layers of 1080p resolution.

Another issue with the existing HEVC level definition is that a decoder implemented in such a way as to be capable of decoding both a single-layer HEVC bitstream of 1080p and a two-layer SHVC bitstream of 720p would be labeled Level 3.1. However, the Level 3.1 label does not express the capability to decode a single-layer bitstream of 1080p.

In another example, for a decoder implemented using 4 single-layer HEVC 3.1 decoders to be able to decode 4 SNR layers of 720p, per the existing level definition, the decoder would have to conform to Level 4 or above. Thus, the decoder would be required to be able to decode bitstreams having more than 3 tile rows and more than 3 tile columns, each tile having a width of 256 luma samples and height of 144 luma samples. However, the Level 3.1 limits of the decoder would not be able to decode some such bitstreams.

Under the existing design of SHVC, all items in subclause A.4.1 of the HEVC text are specified to be applied to each layer. However, some items are not directly applicable to each layer. For example, for item d on decoded picture buffer (DPB) size, the Sequence Parameter Set (SPS) syntax element is not applicable for enhancement layers. Also, the DPB in SHVC WD5 is a shared-sub-DPB design, thus item d cannot be directly applied to each layer. As another example, for items h and i on Coded Picture Buffer (CPB) size, for bitstream-specific CPB operations, the parameter cannot be applied to each layer.

Bitstream-specific restrictions on CPB size (by items h and i in sublcause A.4.1 of HEVC text) are needed. However, the items h and i in subclause A.4.1 of HEVC text cannot be directly applied on bitstream level, because if directly applied, the same CPB size limit for single-layer bitstreams would also be the limit for multi-layer bitstreams. This is not scalable to the number of layers and would only allow for low picture quality when there are many layers.

The restrictions by items b, c, d, g, h, i, and j in subclause A.4.2 of HEVC text are specified to be layer-specific only. However, bitstream-specific restrictions by these items should be specified, regardless of whether their layer-specific counterparts are specified.

While certain embodiments are described herein in the context of the HEVC and/or H.264 standards, one having ordinary skill in the art may appreciate that systems and methods disclosed herein may be applicable to any suitable video coding standard or non-standard video codec design. For example, embodiments disclosed herein may be applicable to one or more of the following standards: International Telecommunication Union (ITU) Telecommunication Standardization Sector (ITU-T) H.261, International Organization for Standardization/International Electrotechnical Commission (ISO/IEC) MPEG 1 Visual, ITU-T H.262 or ISO/IEC MPEG-2 Visual, ITU-T H.263, ISO/IEC MPEG 4 Visual and ITU-T H.264 (also known as ISO/IEC MPEG-4 AVC), including the scalable and multiview extensions.

HEVC generally follows the framework of previous video coding standards in many respects. The unit of prediction in HEVC is different from the units of prediction (e.g., macroblocks) in certain previous video coding standards. In fact, the concept of a macroblock does not exist in HEVC as understood in certain previous video coding standards. A macroblock is replaced by a hierarchical structure based on a quadtree scheme, which may provide high flexibility, among other possible benefits. For example, within the HEVC scheme, three types of blocks, Coding Unit (CU), Prediction Unit (PU), and Transform Unit (TU), are defined. CU may refer to the basic unit of region splitting. CU may be considered analogous to the concept of macroblock, but HEVC does not restrict the maximum size of CUs and may allow recursive splitting into four equal size CUs to improve the content adaptivity. PU may be considered the basic unit of inter/intra prediction, and a single PU may contain multiple arbitrary shape partitions to effectively code irregular image patterns. TU may be considered the basic unit of transform. TU can be defined independently from the PU; however, the size of a TU may be limited to the size of the CU to which the TU belongs. This separation of the block structure into three different concepts may allow each unit to be optimized according to the respective role of the unit, which may result in improved coding efficiency.

For purposes of illustration only, certain embodiments disclosed herein are described with examples including only two layers (e.g., a lower layer such as the base layer, and a higher layer such as the enhancement layer) of video and/or audio data. A “layer” of video data may generally refer to a sequence of pictures having at least one common characteristic or parameter, such as a view, a frame rate, a resolution, or the like. For example, a layer may include video data associated with a particular view (e.g., perspective) of multi-view video data. As another example, a layer may include video data associated with a particular layer of scalable video data. Thus, this disclosure may interchangeably refer to a layer and a view of video data. That is, a view of video data may be referred to as a layer of video data, and a layer of video data may be referred to as a view of video data. In addition, a multi-layer codec (also referred to as a multi-layer video coder or multi-layer encoder-decoder) may jointly refer to a multiview codec or a scalable codec (e.g., a codec configured to encode and/or decode video data using MV-HEVC, 3D-HEVC, SHVC, or another multi-layer coding technique). Video encoding and video decoding may both generally be referred to as video coding. It should be understood that such examples may be applicable to configurations including multiple base and/or enhancement layers. In addition, for ease of explanation, the following disclosure includes the terms “frames” or “blocks” with reference to certain embodiments. However, these terms are not meant to be limiting. For example, the techniques described below can be used with any suitable video units, such as blocks (e.g., CU, PU, TU, macroblocks, etc.), slices, frames, etc.

Video Coding Standards

A digital image, such as a video image, a TV image, a still image or an image generated by a video recorder or a computer, may consist of pixels or samples arranged in horizontal and vertical lines. The number of pixels in a single image is typically in the tens of thousands. Each pixel typically contains luminance and chrominance information. Without compression, the sheer quantity of information to be conveyed from an image encoder to an image decoder would render real-time image transmission impossible. To reduce the amount of information to be transmitted, a number of different compression methods, such as JPEG, MPEG and H.263 standards, have been developed. Video coding standards include those previously recited herein.

Multi-Stream Multiparty Conferencing

In some embodiments, in a multi-stream multiparty conference it may be desirable to support multi-stream video, at least two video contents (e.g., one main and one presentation), multi-stream audio, at least 2 audio contents, as well as other additional capabilities. In some aspects, a centralized processor or bridge may act to support these functions. The centralized processor or bridge may receive the multi-stream video/audio data, mix the video/audio data and send the mixed data stream to each of the participants.

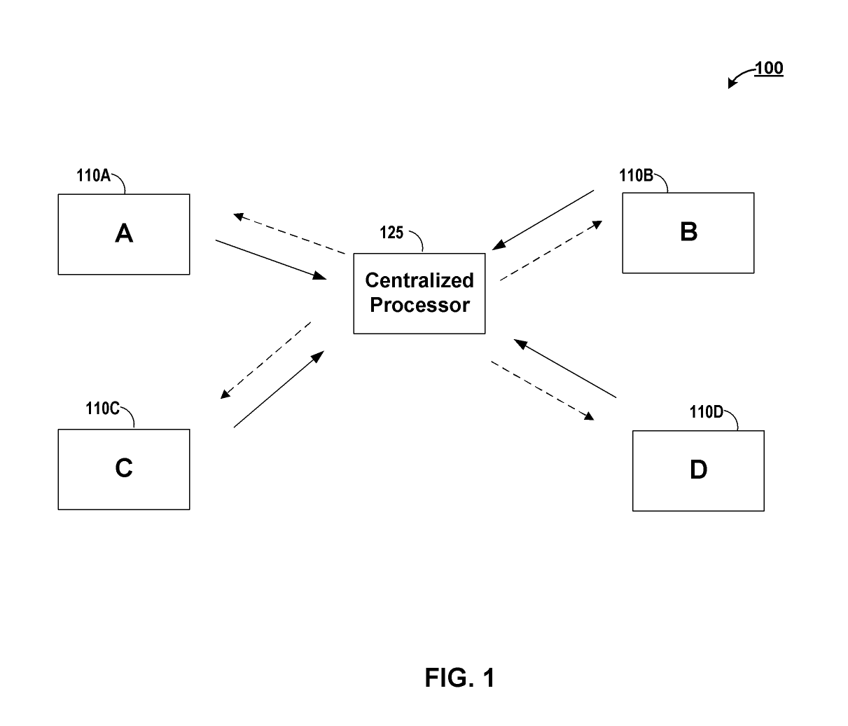

FIG. 1 is a diagram of an exemplary conference architecture 100 for multiple participants. The conference architecture 100 includes terminals 110A-D and the centralized processor 125. In some aspects, the centralized processor 125 may comprise a server or a conference bridge provider. The centralized processor 125 may receive data streams from each of the terminals 110A-D, decode, mix and transmit the mixed data stream to the terminals 110A-D. In some aspects, the centralized processor 125 may transmit the mixed data stream using a multicast transmission. In some embodiments, a data stream may comprise one or more audio, video, and/or media streams. In some aspects, the terminals 110A-D may each comprise one or more of a processor, a receiver, a transmitter, a transceiver, an antenna, a memory, a database, and a user interface.

In some embodiments, it may be desirable to establish a multi-stream multiparty conference without the centralized processor 125. For example, the centralized processor 125 may require separate infrastructure and services that may add cost and/or complexity. Additionally, participants may be required to establish or register with the centralized processor 125 prior to the multi-stream multiparty conference. Accordingly, it may be desirable for participants to establish a multi-stream multiparty conference on their terminals (e.g., computer, tablet, smartphone, other user equipment, etc.) without using the centralized processor 125 (e.g., decentralized conference).

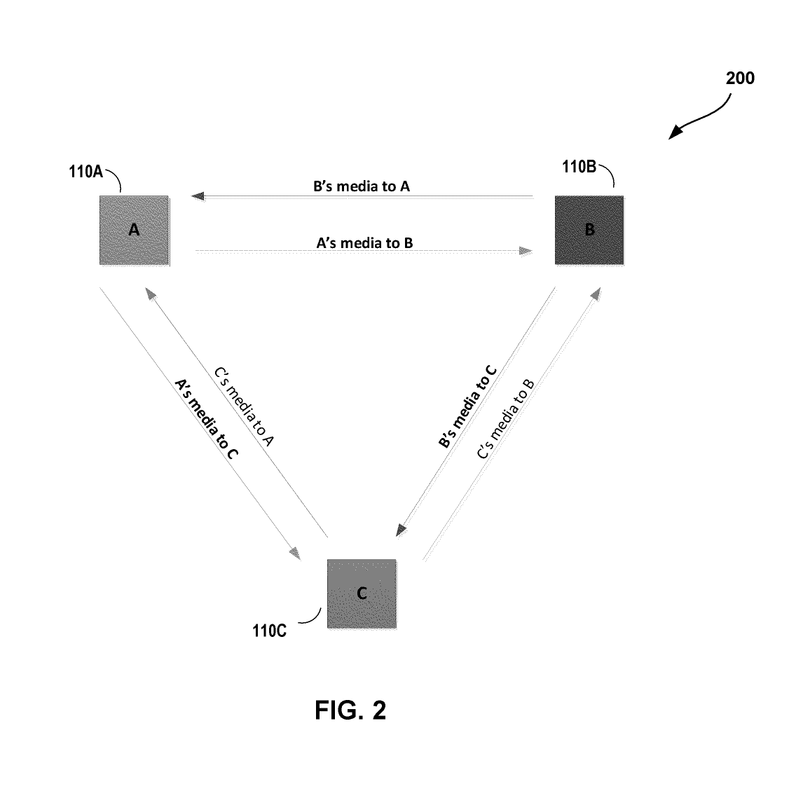

FIG. 2 is a diagram of an example of a decentralized conference architecture 200 for multiple participants. As shown in FIG. 2, the decentralized conference architecture 200 may include terminals 110A, 110B, and 110C. The terminals 110A, 110B, and 110C may exchange data streams with each other and may decode, encode, and/or mix the data streams it receives and/or sends. For example, as shown in FIG. 2, participant 110A receives data streams from terminals 110B and 110C and transmits data streams to terminals 110B and 110C. The data streams may comprise media streams, audio streams, video streams, or a combination of such streams. These multiple data streams may be independently and concurrently decoded then mixed together at each terminal, preferably with some perceptual spatial-separation, before rendering the mixed data stream to the viewer or listener. Each of the terminals 110A, 110B, and 110C may have computational limits on the number of decoder/encoder instances that they can operate concurrently. In some aspects, it may be desirable to take these limits into account by a conference initiator when setting up a multi-stream multiparty conference with in-terminal mixing (e.g., a decentralized conference).

As described above with respect to FIG. 2, each of the terminals 110A, 110B, and 110C may be required to concurrently decode multiple data streams received from the other conference participants. Each terminal 110 may have a computational limit to the number of decoder instances it can operate concurrently. This limits the number of participants that can be in a conference with the terminal, or requires that the terminal has the ability to prioritize decoding certain data streams and ignore others. For example, if a terminal does not ignore any data streams it receives, the number participants must be less than or equal to the maximum number of decoders plus one (N<=MaxDec+1). Where N is the number of participants in the conference, including the conference initiator and MaxDec is the maximum number of decoders that can be run concurrently by the terminal. In some embodiments, terminal 110A may initiate a conference by connecting with terminals 110B and 110C and then terminals 110B and 110C may connect with each other to complete the conference.

With reference to FIG. 2, if terminal 110A is the conference initiator, the terminal 110A may use the above calculation to determine how many callers/terminals to invite to the conference (i.e., N−1). Furthermore, if each of the other terminals (e.g., terminals 110B and 110C) does not prioritize and ignore data streams it receives, each terminal may also be able to decode N−1 data streams. Therefore, it may be desirable for the initiator terminal 110A to consider the following limitation: N<=Min [MaxDec of each terminal]+1. Thus, the initiator terminal 110A accounts for the maximum number of decoders that can be run concurrently by each participating terminal in the conference and can ensure that the number of participants does not exceed the smallest maximum number of decoders plus one.

Similarly, conferences with in-terminal mixing can require that a terminal concurrently encode multiple data streams that are sent to the other participating terminals. This can happen when the initiator offers more than one type of codec for a data type and the other participants select to use different codecs. In some aspects, a data type may comprise an audio type, a video type, or other media type.

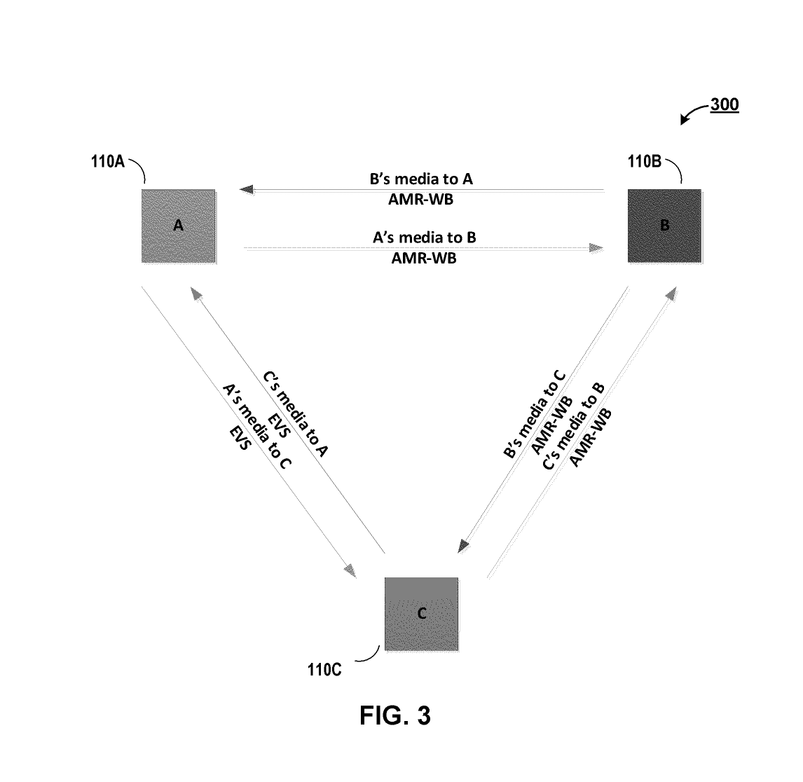

FIG. 3 illustrates another example of a decentralized conference architecture 300 for multiple participants. In some embodiments, the initiator terminal 110A may offer multiple codecs to the terminals 110B and 110C. For example, as shown in FIG. 3, the terminal 110A offers both an enhanced voice services (EVS) codec and an adaptive multi-rate wideband (AMR-WB) to terminals 110B and 110C. In some aspects, the offer may comprise a session description protocol (SDP) offer message. As shown, terminal 110C supports EVS and responds with a message selecting EVS. Terminal 110B may only support AMR-WB and select AMR-WB in its response to terminal 110A. In some aspects, the messages terminals 110B and 110C send in response to the offer from terminal 110A may comprise an SDP answer message. Terminals 110B and 110C may also perform their own codec negotiation (e.g., set-up via the session initiation protocol (SIP) REFER method from terminal 110A) in which they choose AMR-WB since terminal 110B does not support EVS. As can be seen from FIG. 3, terminals 110A and 110C have to both encode their content in the EVS and AMR-WB formats concurrently while terminal 110B need only encode/decode in the AMR-WB format.

As described above, in some embodiments terminals may establish a conference session without a centralized processor or central focus by using the SIP REFER method. In some aspects, the initiator terminal (e.g., terminal 110A) first establishes one-to-one SIP dialogs with each of the other (N−1) participants (terminals 110B and 110C). Once the dialogs are established, terminal 110A then issues multiple SIP REFER messages to each of the other participants requesting them to establish a session with each of the other (N−2) participants. This is done by including the SIP uniform resource identifier (URI) indicating SIP INVITE messages to the other terminals 110B and 110C as the “Refer-To URI.”

For example, terminal 110A may issue a REFER message to terminal 110B, requesting terminal 110B to send an INVITE message to terminal 110C. For redundancy and to minimize conference set-up delay, terminal 110A may also send a reciprocal REFER message to terminal 110C, requesting terminal 110C to send an INVITE message to terminal 110B. If there were more participants, e.g., a fourth terminal 110D, terminal 110A would send at least one additional REFER message each to terminal 110B and terminal 110C requesting that they also send INVITE messages to terminal 110D. In some aspects, to introduce redundancy and minimize conference set-up delay, terminal 110A should also send a REFER to terminal 110D requesting that it also send INVITE messages to terminals 110B and 110C.

In some embodiments, when redundant INVITE messages are requested by the conference initiator terminal 110A via the REFER messages, a terminal that receives a REFER message requesting it to send an INVITE message to a terminal from which it has already received an INVITE message should no longer send an INVITE message to that terminal.

In some aspects, to decrease overall SIP signaling load in the network at the cost of potentially increasing the conference set-up time, the initiator terminal 110A may decide not to request redundant INVITE messages be sent among the participants. For example, if the participants are numbered 1 to N, with 1 being the initiator terminal 110A, the initiator terminal 110A sends the following:
A REFER message to terminal 2 requesting that it send INVITE messages to terminals 3 to N
A REFER message to terminal 3 requesting that it send INVITE messages to terminals 4 to N
A REFER to terminal M requesting that it send INVITE messages to terminals M+1 to N
A REFER message to terminal N−1 requesting that it send an INVITE to terminal N.

In some embodiments, when issuing REFER requests, the terminal 110A may not send a REFER message to each participant in the conference (e.g., terminals 110B and 110C) giving them each the identities of the other (N−2) participants. In some aspects, the following procedure can be followed:
1. The initiator terminal (e.g., terminal 110A) constructs an ordered list of conference participants (e.g., terminals 110B and 110C) and identifies each participant terminal by its position in this list. In some aspects, the list comprises a list of the URI associated with each participant. Assuming the conference contains N participants including the initiator terminal, the initiator terminal may be positioned at the top of the list (position 1). In some aspects, the initiator terminal already has a 1-1 session with each of the (N−1) participants.
2. The initiator terminal (e.g., terminal 110A) sends a REFER message to (N−2) participants that are numbered 2, 3, . . . , (N−1). For example, as shown in FIG. 3, terminal 110A would send one REFER message (i.e., 3-2) to the participant terminal 110B (e.g., for terminal 110B numbered 2 and terminal 110C numbered 3). In some aspects, each REFER message may contain a URI list of different lengths. The URI list sent to participant terminal i (where 2<=i<=(N−1)) contains (N−1) entries. The URI list may comprise URIs of the participant terminals numbered (i+1), (i+2), . . . N. For example, as shown in FIG. 3, the URI list sent to terminal 110B (i.e., terminal 2) may comprise the URI of terminal 110C (i.e., terminal 3).
3. Upon reception of the REFER message, each participant terminal may send INVITE messages to the list of participant terminals provided to it by the initiator terminal and session set up proceeds normally. Continuing the example from FIG. 3, terminal 110B (i.e., terminal 2) may send an INVITE message to terminal 110C (i.e., terminal 3) which was listed in the REFER message sent by terminal 110A (initiator terminal).

In the above procedure, it may be possible to minimize the total amount of signalling generated to establish the N-way session from (N−1)*(N−1) to N*(N−1)/2. In some aspects, participant N (e.g., terminal 110C of FIG. 3) does not receive any REFER message, but only receives INVITE messages from the other (N−2) participants (e.g., terminal 110B of FIG. 3). In some embodiments, if redundancy is desired, then the URI list in a REFER message can be lengthened to allow some overlap. When the length of URI list in the REFER message is the same for all participants, full redundancy may exist. For example, in the scenario above, the URI list sent to participant i could be made to be (N−i+1) terminals. In such embodiments, each participant would get the complete URI list so that it is aware of the identities of all other participants. However, it sends out an INVITE message only to those terminals that appear in the list after its own identity and waits to receive the INVITE message from those terminals whose identities appear before its own identity in the list. In case no INVITE message is received from such a terminal, this terminal could send an INVITE message towards that terminal.

For terminal 110A (initiator terminal), it may be desirable to consider the following limitation: the minimum of the number of types of codecs it offers and the value of N−1, should be less than or equal the maximum number of encoders that can be run concurrently by the terminal 110A (Min [# of types of codecs in the offer, (N−1)]<=MaxEnc). Where MaxEnc is the maximum number of encoders that can be run concurrently by the terminal 110A. For example, if the terminal 110A can offer 3 types of codecs and there are 3 total participants, then the minimum of the number of types of codecs it offers and the value of N−1 would equal 2 which would be less than or equal to the maximum number of encoders that can be run concurrently by the terminal 110A.

Additionally, as was discussed above with respect to decoding with multiple terminals, it may be desirable for the terminal 110A to consider that the number of types of codecs should also be less than the MaxEnc of each terminal involved in the conference. Therefore the following limit should be followed: Min [# of types of codecs in the offer, (N−1)]<=Min [MaxEnc of each terminal].

In some embodiments, it may be desirable for the terminal 110A (initiator terminal) to consider additional constraints. For example, for a given data type, the different types of codecs may have different computational complexity requirements. For example, the EVS codec may have a higher complexity level than the AMR-WB codec. This may require that the conference initiator (terminal 110A) consider the following for each codec it includes in an offer message: the minimum of the maximum number of encoders that can be run concurrently by the terminal 110A of each codec and the minimum of the maximum number of decoders that can be run concurrently by the terminal 110A of each codec. The above may also be expressed as: Min [MaxEnc of each coded] and Min [MaxDec of each coded]. In some aspects, each terminal may communicate its MaxEnc and MaxDec for each of the codecs it supports.

In a decentralized conference, a terminal performs both encoding and decoding. If these processes run on the same processors, then the MaxEnc and MaxDec may depend on how many instances of each operation (encode/decode) are running. Conceptually, the limitation can be generalized as follows: Complexity [operational encoders+operational decoders]<=Complexity Limit. That is, the complexity of the operational encoders plus the complexity of the operational decoders should be less than or equal to the complexity limit for the terminal.

In one embodiment, a terminal can trade off the amount of complexity it allows for encoding and decoding. For example, if the terminal 110A is going to initiate a conference proposing only one codec type for the data (i.e., a mandatory codec) then it knows that it will not need more than one encoder instance and can use more of its processor resources for decoding. This may allow it to increase N as long as it knows that other terminals (e.g., terminals 110B and 110C) also have the necessary decoding capabilities for the selected codec. Alternatively, the terminal 110A may choose to propose more codec types as it only plans to initiate a small conference, with N equal to a small value.

In some multi-stream multiparty conferences, a terminal performs both audio and video coding. If these processes run on the same processors, then the MaxEnc and MaxDec may depend on how many instances of each operation for each data type are running. Conceptually, the limitation can be generalized as follows: Complexity [operational audio codecs+operational video codecs]<=Complexity Limit. That is, the complexity of the operational audio codecs plus the complexity of the operational video codecs should be less than or equal to the complexity limit for the terminal.

In one embodiment, a terminal can also trade off the amount of complexity it allows for encoding and decoding among the different data types. For example, if the terminal 110A is going to initiate a conference proposing only one codec type for the video (i.e., a mandatory video codec like H.264) then may know that it won't need more than one video encoder instance and can use more of its processor resources for decoding video and audio encoding/decoding. This may allow the terminal 110A to increase N or propose more speech codecs (e.g., EVS, AMR-WB, AMR) for the audio data type.

In some embodiments, a terminal can extend its ability to handle a conference with N users even if N>Min [MaxDec of each terminal]+1, as long as the terminal and all the other terminals in the conference do not decode all of the data streams they receive. This requires that the terminals have a means for choosing which data streams to prioritize and which ones to ignore based on certain parameters of the data streams. As described below, the parameters may comprise a transmission mode, a volume level, a complexity level, an activity level, a packet size, etc.

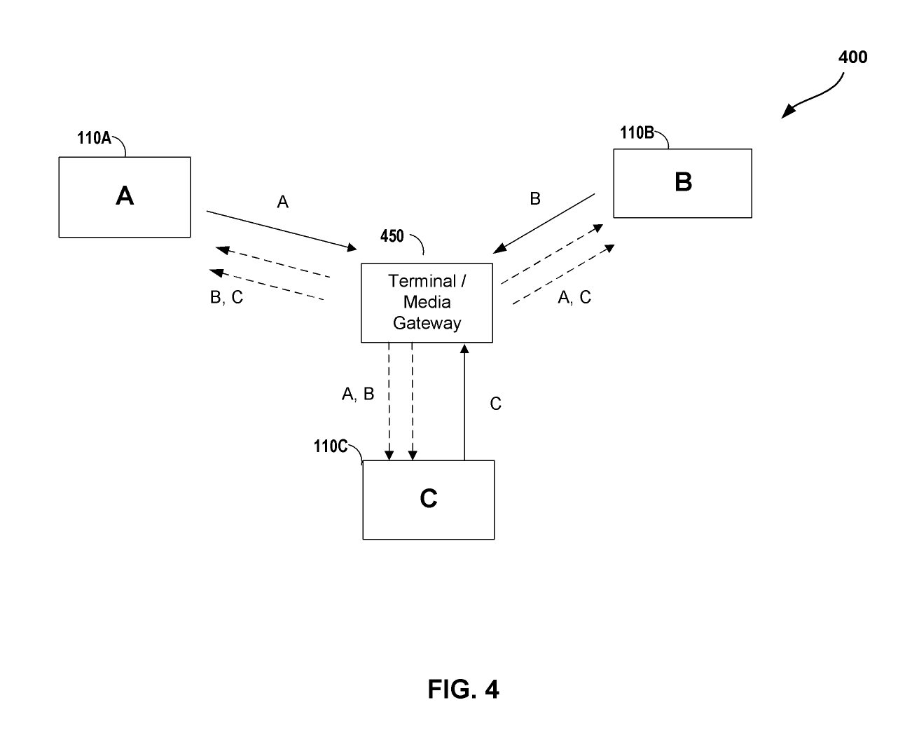

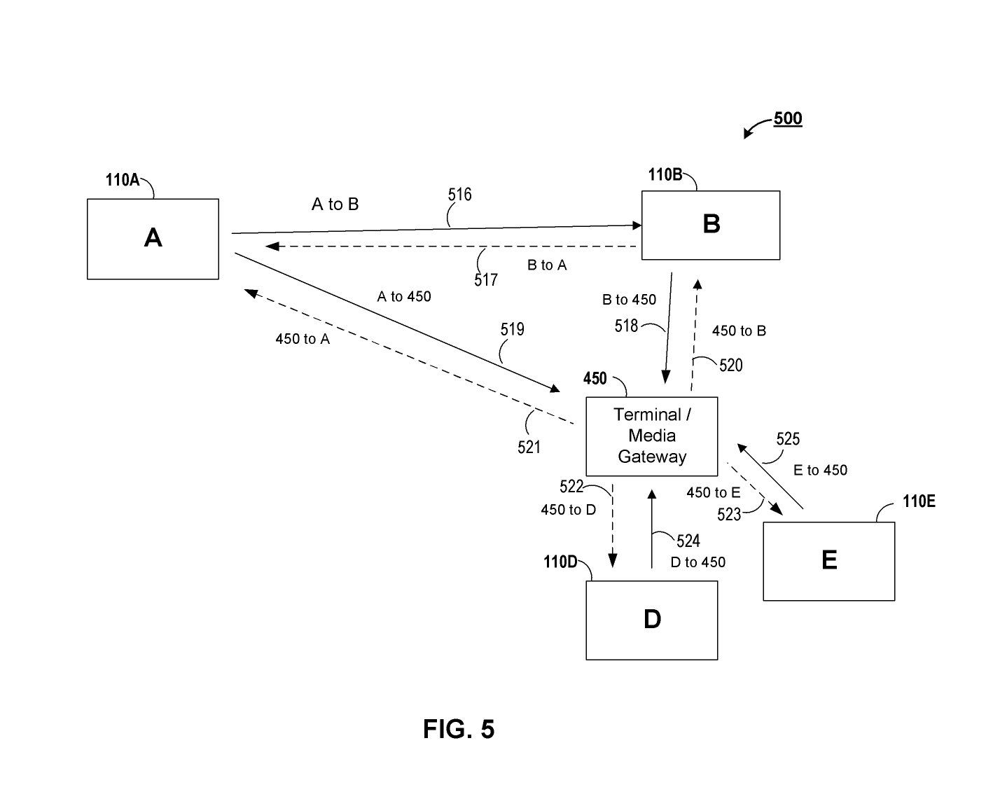

In an example embodiment, a terminal may inspect the multiple RTP streams received from the conference participants and/or a media gateway (e.g., terminal/media gateway 450 of FIGS. 4 and 5 discussed below). For example, depending on the RTP packet length and the participant ID, the terminal may distinguish between an active speech (typically coded at a higher bit rate, e.g., 13.2 kb/s) and an inactive/background portions (typically coded using DTX e.g., 2.4 kb/s); and participant ID 2 or 3 or . . . (N−1). The terminal may track at each RTP packet instance, the active speakers among the list of participants. The active speaker information may be stored and analysed for selecting the priority of which of the recent active participant RTP streams can be decoded and which of the non-active streams are not sent for decoding.

Prioritization Based on Past Active Speaker

In the case of speech, this selection could be made based on which data streams are or are not in a certain mode (e.g., DTX mode). In most cases, talkers may naturally floor or yield control to each other as it is difficult to listen to more than two speakers at the same time. Therefore, a terminal that can decode up to two or three concurrent data streams could handle most audio conference configurations. However, it should be noted that there will still be some operational complexity increase with increasing N as the terminal has to inspect the voice packets (at least for size) from the data streams to determine which are active.

Prioritization Based on RTP Level Limitation

In another embodiment, a terminal (terminal 110A) can search through the data streams it is receiving and choose to mix (prioritize) the first MaxDec data streams that are active. After finding MaxDec active data streams, it stops searching through the others, thus saving some computational complexity.

It is also possible for the terminal 110A to attempt to prioritize the data streams with the loudest volumes. This prioritization may require decoding of the data from each data stream to determine the loudest MaxDec data streams. The terminal 110A could save some complexity if the sampling/selecting is not performed for every voice frame, e.g., periodically at longer intervals.

For video, it may not be as simple to dynamically select which data streams to prioritize and ignore as there are not the same concepts of modes (e.g., DTX mode) and volume. Looking at other criteria, such as the amount of movement, may involve significant complexity. Other criteria, such as looking at the size of data packets, might be used to get an idea of motion/new information in particular data streams.

Video may also have the additional challenge that most of the frames in the data streams are differentially encoded with respect to previous video frames in the data stream. If a data stream is ignored, it cannot simply be decoded again until an independently-decodable (e.g., IDR) frame, or a frame whose reference frame has already been pre-stored, is received. In one embodiment, selection of the data stream to decode can be based on the corresponding audio packet length. For example, if the audio associated with a video packet is DTXed (small packet size), then the terminal 110A may determine to not decode the video and display the last frame (freeze picture). Then, based on the last three active talkers, the receiver (e.g., terminal 110A) can prioritize which data streams to decode. When the receiver receives a video IDR frame in a given data stream, it can select to decode that frame, display it, and/or keep it as a reference frame. If there is not much motion then an IDR frame may be received less frequently and it may be sufficient to display the IDR frame. In some aspects, if the conference participant does not talk (not active talker) but moves a lot, then the receiver (e.g., terminal 110A) can fall back on using the audio packet length to decode the video.

In some embodiments, some or all of the decoding capabilities described above with respect to a decentralized conference architecture may be applied to a centralized or hybrid conference architecture. Referring back to FIG. 1, the centralized processor 125 may receive data streams from each of the terminals 110A-D, decode, mix and transmit the mixed data stream to the terminals 110A-D. In other aspects, the centralized processor 125 may receive data streams from each of the terminals 110A-D, decode, mix and transmit the data stream to some terminals and may send multiple data streams to other terminals. In some aspects where one or more of the terminals 110A-D receive multiple data streams, the terminals 110A-D receiving multiple data streams may rely on the parameters described above to ignore, select, or prioritize which data streams to decode. For example, as shown in FIG. 1, terminals 110A-D may send data streams to the centralized processor 125. The centralized processor 125 may then decode and mix the received data into a mixed data stream and transmit the mixed data stream to the terminals 110A-C. The centralized processor 125 may also transmit multiple data streams to terminal 110D (e.g., the three data streams from terminals 110A-C).

In some aspects, terminal 110D and/or the centralized processor 125 may be limited in the number of data streams they may concurrently process or encode/decode. In the example described above with reference to FIG. 1, terminal 110D may receive the three data streams from terminals 110A-C but may only be capable of decoding two data streams. Similarly, the centralized processor 125 may receive four data streams (e.g., one from each of the terminals 110A-D) but may only be capable of decoding three data streams. Accordingly, terminal 110D and/or the centralized processor 125 may prioritize, select, and/or ignore certain data streams based on certain parameters. For example, terminal 110D and/or the centralized processor 125 may prioritize received data streams to decode the two or three loudest volume data streams and ignore the lowest volume data stream.

Additionally, as discussed with respect to the decentralized architecture of FIGS. 2 and 3, the terminal 110 initiating the conference (e.g., terminal 110A) should consider the encoding/decoding limitations of the other terminals 110 participating in the conference (i.e., terminals 110B-D) along with the centralized processor 125 encoding/decoding limitations. For example, the initiator terminal 110A may consider one or more of the above limitations for the number of participants in a conference, for example: N<=Min [MaxDec of each terminal/centralized processor]+1; Min [# of types of codecs in the offer, (N−1)]<=Min [MaxEnc of each terminal/centralized processor]; for a codec being offered, Min [MaxEnc of each codec] and Min [MaxDec of each coded]; Complexity [operational encoders+operational decoders]<=Complexity Limit; and/or Complexity [operational audio codecs+operational video codecs]<=Complexity Limit.

FIG. 4 is a diagram of an exemplary hybrid conference architecture 400 for multiple participants where a terminal/media gateway 450 functions as a mixer. As shown in FIG. 4, terminals 110A-C may each send a data stream to the terminal/media gateway 450 which then sends multiple data streams to the terminals 110A-C. For example, terminal/media gateway 450 may receive data streams from terminals 110B and 110C, decode and send those data streams to terminal 110A. In some aspects, terminal/media gateway 450 may mix the data streams from terminals 110B and 110C and send a mixed data stream to terminal 110A.

In one implementation, terminal 110A may adjust the number of data streams it receives from the terminal/media gateway 450 based on certain limitations or conference parameters. For example, terminal 110A may utilize the terminal/media gateway 450 (or centralized processor 125 of FIG. 1) processing capabilities to reduce or off-load its own processing or ensure efficient communication within the conference architecture (either centralized, decentralized, or hybrid) limitations. In one aspect, the terminal 110A may request the terminal/media gateway 450 to only send one mixed data stream because the terminal 110A may only be capable of decoding one data stream or because the terminal 110A has limited processing power.

Additionally, it may be possible for terminals 110A-D, the centralized processor 125, and/or the terminal/media gateway 450 in FIGS. 1-4 (and FIG. 5 below) to switch capabilities. For example, the terminals 110A-D and the centralized processor 125 may be operating in the conference architecture 100 of FIG. 1 and the centralized processor 125 may lose power or lose mixing capabilities. In some aspects, the terminal 110D may switch from operating as a conference participant into operating as the non-participating terminal/media gateway 450 of FIG. 4, essentially replacing the centralized processor 125 functions. Additionally, the terminal/media gateway 450 of FIG. 4 may also operate as a participating terminal/media gateway 450 in the conference by sending its own data streams to one or more participants in the conference (e.g., terminals 110A-D). Accordingly, each of the terminals 110A-D, the centralized processor 125, and/or the terminal/media gateway 450 may be configured to operate in one or more of the centralized conference architecture 100 of FIG. 1, the decentralized conference architectures 200 and 300 of FIGS. 2 and 3, and the hybrid conference architecture 400 of FIG. 4.

In one example, a conference (e.g., conference architectures 100, 200, 300, 400, and 500 [discussed below]) may have a conference duration that comprises a first duration and a second duration. In some aspects, during the first duration terminal 110D may operate as a conference participant as illustrated in FIG. 1. In some aspects, during the second duration, the terminal 110D may switch to operating as the terminal/media gateway 450 as depicted in FIG. 4 (and FIG. 5 below). In some aspects, the terminal 110D may request to switch operating functions to the centralized processor 125, to one or more of the terminals 110A-C (as illustrated in FIG. 1), or to another controller or device. In other aspects, the centralized processor 125 or one or more of the terminals 110A-C (as illustrated in FIG. 1) may determine that terminal 110D is capable of switching to operating as the terminal/media gateway 450.

In some aspects, a conference initiation or association may occur during the first duration and an exchange of conference data may occur during the second duration. For example, with respect to FIGS. 2 and 3 the terminal 110A, during the first duration, may transmit an offer message to terminals 110B and 110C including a list of codec capabilities supported by terminal 110A. The terminal 110A may receive a response message from each of the terminals 110B and 110C. The response message may include a list of codec capabilities of the respective terminal 110B or 110C and a codec type selected by the terminals 110B and 110C. The terminal 110A may determine whether each of the terminals 110B and 110C can participate in the conference based on the list of codec capabilities in each of the response messages. During the second duration, the terminals 110A-C may exchange data streams amongst each other.

In some aspects, the centralized processor 125 or one or more of the terminals 110A-C may request that the terminal 110D switch to operating as the terminal/media gateway 450. In some embodiments, the request may be based on the terminal 110D's encoding/decoding capabilities and/or based on the centralized processor 125 or one or more of the terminals 110A-C encoding/decoding capabilities. For example, the terminal 110A may determine that it can only receive two data streams and may request the terminal 110D to switch operations. The request may include requesting that the terminal 110D process and mix communications from terminals 110B and 110C and that terminal 110D send the mixed data stream to terminal 110A. In some aspects, the request may be transmitted to terminals 110B and 110C from one of terminal 110A, 110D, or the centralized processor 125 indicating that the new conference identifier or conference uniform resource identifier (URI) for terminals 110B and 110C is an address for terminal 110D. In some aspects, the request or the indication of the new destination (i.e., terminal 110D) for processing and mixing data streams for terminals 110B and 110C may be sent via an out of band communication. In response to the request, terminals 110B and 110C may then switch from sending data streams to the centralized processor 125 to sending data streams to the terminal 110D. In order to reduce potential latency issues involved with the switch, terminals 110B and 110C may send data streams to both the centralized processor 125 and terminal 110D until a time where the centralized processor 125 and/or terminal 110D determine that the switch is complete.

FIG. 5 is a diagram of an exemplary hybrid conference architecture 500 for multiple participants where the terminal/media gateway 450 functions as a mixer and participant. As shown in FIG. 5, terminal 110A may initiate a conference with terminal 110B, terminal/media gateway 450, and terminals 110D-E as participants in the conference. Terminal 110A may initiate a conference by any method such that the participants (terminal 110B, terminal/media gateway 450, and terminals 110D-E) join the conference. For example, the terminal 110A may initiate the conference using an out of band communication with the participants (e.g., email communication indicating the conference and/or a conference bridge). In some aspects, terminal 110A may also initiate the conference by employing the REFER method described above for terminal 110B and terminal/media gateway 450 in combination with an out of band communication to terminals 110D and 110E for those terminals to join the conference via the terminal/media gateway 450. In other aspects, the terminal 110A may initiate the conference through a poll message announcing a start of the conference and the terminals 110B and 110D-E and the terminal/media gateway 450 may transmit a message with their codec capabilities to join the conference. As described above, other methods to initiate the conference are also possible.

As discussed above with respect to FIGS. 1-4, terminal 110A may consider the encoding/decoding capabilities of each of the participants when initiating the conference. In FIG. 5, terminal 110A may transmit data stream 516 to terminal 110B, transmit data stream 519 to terminal/media gateway 450, and receive data streams 517 and 521 from terminal 110B and terminal/media gateway 450, respectively. Terminal 110B may also transmit data stream 518 to terminal/media gateway 450 and receive data stream 520 from terminal/media gateway 450. Terminal/media gateway 450 may also receive data streams 524 and 525 from terminals 110D and 110E, respectively, and transmit data streams 522 and 523 to terminals 110D and 110E, respectively. Each of the data streams 516-525 may comprise one or more audio and/or video (media) streams.

In some embodiments, terminal/media gateway 450 functions as both mixer and participant in a conference. For example, terminal/media gateway 450 may receive data stream 519 from terminal 110A, data stream 518 from terminal 110B, data stream 524 from terminal 110D, and data stream 525 from terminal 110E. In some aspects, terminals 110D and 110E may only be able to decode one data stream each while terminals 110A and 110B may each be able to decode three data streams. In some aspects, terminals 110A and 110B may be considered new or high efficiency terminals compared to terminals 110D and 110E. In some aspects, terminals 110D and 110E may be considered legacy or older devices than terminals 110A and 110B. In one embodiment, terminal/media gateway 450 may transmit a single mixed data stream 522 to terminal 110D and a single mixed data stream 523 to terminal 110E. In some aspects, the terminal/media gateway 450 may transmit a multicast mixed data stream to terminals 110D and 110E while concurrently sending unicast data streams 521 and 520 to terminals 110A and 110B. Additionally, terminal/media gateway 450 may transmit data stream 521 to terminal 110A which may comprise a data stream from terminal 110B, a data stream from terminal/media gateway 450, and a mixed data stream from terminals 110D and 110E.

In other aspects, terminal/media gateway 450 may transmit other combinations of data streams from the other participants in the conference. For example, terminal/media gateway 450 may ignore the data stream from terminal 110E and transmit only the data streams from terminals 110B, 110D, and terminal/media gateway 450 to terminal 110A. Terminal/media gateway 450 (and any of the terminals 110A, 110B, 110D, and 110E) may prioritize, select, and/or ignore certain data streams in accordance with any of the implementations or combinations described herein. In another example embodiment, the terminal/media gateway 450 may receive data streams from terminals and identify the streams that are active speech (e.g., 110B, 110C) and that are background/inactive speech (e.g., 110D, 110E). The terminal/media gateway 450 may choose to decode and mix the DTX/inactive frames and transmit as one inactive frame along with the multiple active frames (e.g., to terminal 110A). In a multiparty conference with large number of participants (e.g., N>10), the above discussed selective pre-parsing and mixing of DTX/inactive frames at the terminal/gateway 450 may reduce the number of multiple streams received at a terminal for processing. The receiving terminal (e.g., 110A) may now have fewer streams to inspect and prioritize for decoding. In another example embodiment, the terminal/media gateway 450 may determine the corresponding video streams associated with the DTX/inactive frames and perform tiling/re-encoding of those video/image data streams into one video stream, thereby reducing the number of multiple video streams received at a terminal for processing.

As discussed above with respect to FIG. 4, in some aspects, any of the terminals 110A, 110B, 110D, 110E and the terminal/media gateway 450 of FIG. 5 may switch operating functions in a variety of ways. For example, terminal 110B and the terminal/media gateway 450 may determine (e.g., via out of band communication or through analysis of codec capabilities) to transfer mixing operations of the terminal/media gateway 450 to terminal 110B. In some aspects, the terminal/media gateway 450 and/or the terminal 110B may broadcast to the other conference participants either directly or indirectly (e.g., out of band or through another terminal) that terminal 110B is taking over the processing and mixing operations of the terminal/media gateway 450. While terminal 110B is discussed as taking over the processing operations of the terminal/media gateway 450, in other embodiments, any of the terminals 110A, 110D, or 110E, or another device, may similarly replace the terminal/media gateway 450's processing and/or mixing operations.

In other embodiments, the terminal/media gateway 450 may utilize the REFER method to broadcast to the other conference participants to transfer the conference data streams that the conference participant is sending to the terminal/media gateway 450 to now send the conference data streams to terminal 110B. In addition, the conference participants may send their respective data streams to both the terminal/media gateway 450 and terminal 110B for a period of time until all conference participants are transmitting their data streams to terminal 110B. Similarly, the terminal/media gateway 450 and terminal 110B may for a period of time both concurrently process and mix multiple data streams they receive from the other conference participants until the terminal/media gateway 450 and/or terminal 110B have determined that all terminals have switched over in order to reduce potential interruption or latency issues.

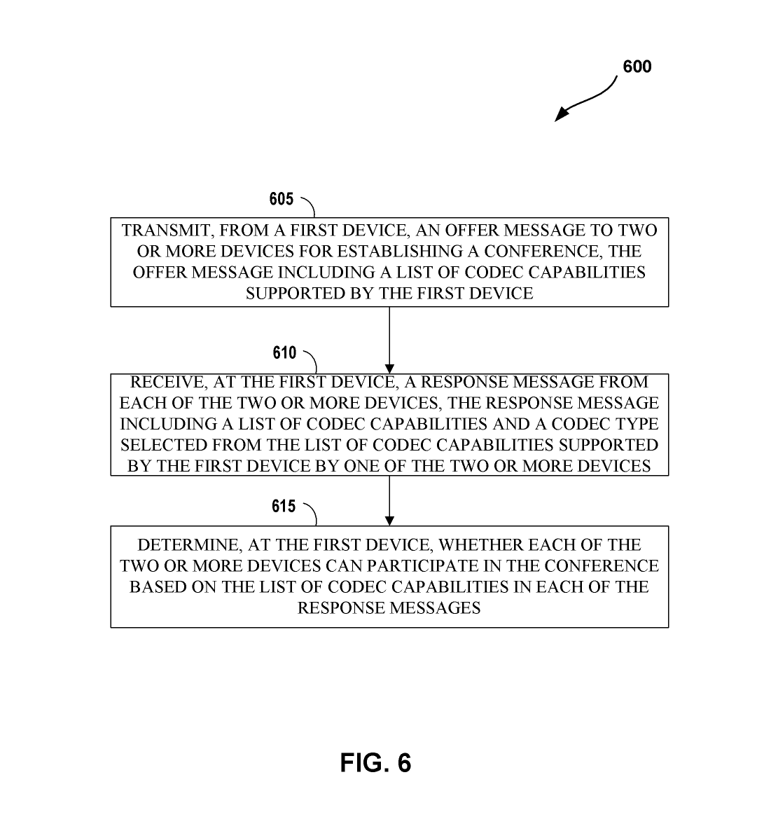

FIG. 6 is a flowchart of an exemplary method 600 of codec negotiation in a decentralized multimedia conference. The method 600 shown in FIG. 6 may be implemented via one or more devices in the conference architecture 200 and/or 300. In some aspects, the method may be implemented by a device similar to the user terminals 110A-D of FIGS. 1-3, or any other suitable device.

At block 605 an initiator terminal (terminal 110A) may transmit an offer message to two or more devices for establishing a conference. The offer message may include a list of codec capabilities supported by the initiator terminal. In some embodiments, the offer message may also be based on the codec capabilities of the other participants for which their concurrent capabilities are known beforehand (terminals 110B and 110C).

At block 610, the initiator terminal receives a response message from each of the two or more devices. The response message includes a list of codec capabilities supported by the transmitting device of the two or more devices and a codec type selected from the list of codec capabilities supported by the first device by one of the two or more devices. The codec capabilities information included in the offer message and/or the response message may indicate the capabilities per codec, independently indicate capabilities for the encoder and decoder of each codec, indicate whether concurrent operation of an encoder and/or decoder of different codecs share the same computational resource, and/or indicate that the terminal decoding capabilities do not pose a constraint because the terminal is able to intelligently trim or reduce (e.g., through prioritizing certain data streams as discussed above) the number of data streams to match its concurrent decoding capabilities.

In some embodiments, there may be a trade-off between the granularity of the information to be provided and the ability to indicate the capability to support more concurrent operations. There may be scenarios or devices where vendors or operators wish to communicate detailed information about the concurrent sessions that can be supported, e.g., high-end business terminals specifically designed for multiparty conferencing. On the other hand, there may be mid- to low-end terminals that are not designed to support more than three-to-four participants in a session which the vendor or operator only wishes to expose very basic functionality. Since the appropriate amount of information to be communicated may depend on the scenario and device, it may be desirable to accommodate the different cases. Instead of choosing one of the formats described above, in some aspects, a terminal (e.g., terminals 110A-E or terminal/media gateway 450) may be able to choose any of the described formats. The initiator terminal (e.g., terminal 110A), who has to receive all the codec capabilities information from the conference participants should be able to decode and understand all the formats.

One example that meets the above format requirements for the codec capabilities information is to communicate a maximum number of concurrent implementations of each data type (e.g., audio or video), or each codec.

Limits Per Data Type

For example, new session-level SDP attributes could be defined as follows:
a=max_dec_audio:<num_instances>
a=max_dec_video:<num_instances>
a=max_enc_audio:<num_instances>
a=max_enc_video:<num_instances>

In some aspects, <num_instances> is an integer, in the range of 1 to 16, inclusive, that specifies the maximum number of concurrent decoders (for the first two) or encoders (for the last two) of that data type (e.g., audio for the 1st and 3rd, or video for the 2nd and 4th) supported by the terminal.

Or, new data-level SDP attributes could be defined as follows:
a=max_dec:<num_instances>
a=max_enc:<num_instances>

In some aspects, <num_instances> is an integer, in the range of 1 to 16, inclusive, that specifies the maximum number of concurrent decoders (for a=max_dec) or encoders (for a=max_enc) of the data type (of the latest above “m=” line) supported by the terminal.

In some embodiments, this exemplary solution may not meet the format requirements for the codec capabilities information described above. In some aspects, the max number of concurrent instances may be constrained by the most computationally-intensive codec. In an exemplary embodiment, for a video telephony session where the terminal supports a H.265 codec and declares that it can support up to two video encoder occurrences (H.264 and H.265), knowing that it has to reserve enough resources for these two video encoders, the terminal may be limited in the number of decoder instances of data (e.g., video or speech) that it can handle.

In some aspects, the limitations on the number of decoder instances may prevent the terminal from being included in conferences with a larger number of participants using a less complex decoder or may prevent all the participants in a conference from using more advanced optional codecs in the session.

Limits Per Codec Type

Additionally, new SDP parameters could be defined as follows:
a=max_dec:<codec><num_instances>
a=max_enc:<codec><num_instances>

In some aspects, <codec> is the data type name of a codec as defined in the RTP payload format for that codec, e.g., “video/H264” for H.264 as defined in IETF RFC 6184 (available here: https://tools.ietf.org/html/rfc6184) and “video/H265” for H.265 as defined in the H.265 RTP payload format (the latest version of which is here: https://tools.ietf org/html/draft-ietf-payload-rtp-h265-14), respectively. In some aspects, <num_instances> is an integer, in the range of 1 to 16, inclusive, that specifies the maximum number of concurrent decoders (for a=max_dec) or encoders (for a=max_eec) of the specified codec.

In other implementations, to take into consideration that a video codec of different levels can be of different capabilities, new data-level SDP attributes could be defined as follows:
a=max_dec:<codec><level><num_instances>[<profile>]
a=max_enc:<codec><level><num_instances>[<profile>]

In some aspects, <codec> is the same as above. In some aspects, <level> specifies the level of the codec, e.g., for H.264 and H.265 the value is equal to level_idc as defined in the ITU-T H.264 specification and level-id as defined in the H.265 RTP payload format (the latest version of which is here: https://tools.ieff org/html/draft-ietf-payload-rtp-h265-14), respectively, and when the codec is EVS, the value of this field being 1, 2, 3 and 4 specifies NB, WB, SWB and FB, respectively. In some aspects, <num_instances> is an integer, in the range of 1 to 16, inclusive, that specifies the maximum number of concurrent decoders (for a=max_dec) or encoders (for a=max_enc) of the specified codec at the specified level and profile (when present). In some aspects, <profile>, which is optional, specifies the profile of the codec, e.g., for H.264 and H.265 the value is equal to profile_idc as defined in the ITU-T H.264 specification and profile-id as defined in the H.265 RTP payload format (the latest version of which is here: https://tools.ietf.org/html/draft-ietf-payload-rtp-h265-14), respectively.

In some embodiments, for all the above alternatives, a value of 0 may also be allowed for <num_instances>, and the value 0 specifies that the terminal is capable of picking and trimming data streams. In some aspects, the terminal capable of picking and trimming data streams can handle an infinite number of data streams.

In other implementations, another alternative for video codec may be to define a new SDP attribute as follows:
a=max_vdec_cap:<codec><max_block_ps>
a=max_venc_cap:<codec><max_block_ps>

In some aspects, <codec> is the same as above. In some aspects, <max_block_ps> specifies the maximum number of 8×8 luma blocks per second that can be processed by all concurrent video decoders (for a=max_vdec_cap) or encoders (for a=max_venc_cap) of the specified video codec.

In some embodiments, this exemplary solution may not meet the format requirements for the codec capabilities information described above. In some aspects, it may not be clear how the conference initiator terminal (e.g., terminal 110A of FIGS. 2-5) can determine exactly how many concurrent encoders and decoders can be supported when there is a mix of codecs. In some embodiments, a way to estimate how many concurrent encoders and decoders can be supported is to use the encoder/decoder limit of the most computationally taxing codec being used. In some aspects, the encoder/decoder limits may be constrained by the most complex codec, which may limit the number of decoder instances of data (e.g., video or speech) that the terminal can handle. For example, in some aspects, the limitations on the number of decoder instances may prevent the terminal from being included in conferences with a larger number of participants using a less complex decoder or may prevent all the participants in a conference from using more advanced optional codecs in the session.

Another example that meets the above format requirements for the codec capabilities information is to describe the percentage of processor resources available or allocated for each encoding/decoding function. This allows the initiator terminal to mix and match codecs, including those of different data types, along with their encoders and decoders as long as it keeps the total complexity load no larger than 100% of the allocated resources in a given processor. One way to describe the above information may be to introduce two new SDP attributes:
a=enc_use:<codec><alloc_factor><proc_idx>
a=dec_use:<codec><alloc_factor><proc_idx>
where <alloc_factor> ranges from 0 to 1.0 and describes the resource allocation factor for the specified codec when using the processor with the processor index <proc_idx> for encoding (for a=enc_use) or decoding (for a=dec_use).

In other embodiments, another way to describe the above information may be to introduce two new SDP attributes:
a=enc_use:<codec><level><alloc_factor><proc_idx>[<profile>]
a=dec_use:<codec><level><alloc_factor><proc_idx>[<profile>]

In some aspects, <codec>, <level>, and <profile> are the same as above. In some aspects, <alloc_factor> ranges from 0 to 1.0 and describes the resource allocation factor for the specified codec at the specified level when using the processor with the processor index <proc_idx> for encoding (for a=enc_use) or decoding (for a=dec_use). In some embodiments, the initiator terminal may use the above information from each participant to ensure that the proposed conference does not exceed any of the concurrent codec capabilities of the participants.

The information can be conceptualized as follows in Table 1:

TABLE 1

| | | Resource | Resource | |
|---|---|---|---|---|
| | | allocation | allocation | |
| Data | | factor for | factor for | |
| Type | Codec Name | encoder | decoder | proc_num |
| Audio | AMR-NB | 0.1 | 0.02 | 1 |
| Audio | AMR-WB | 0.2 | 0.04 | 1 |
| Audio | EVS (WB) | 0.24 | 0.09 | 2 |
| Audio | EVS (SWB) | 0.28 | 0.12 | 2 |
| Video | AVC/H.264 | 0.6 | 0.15 | 1 |
| Video | HEVC/H.265 | 0.9 | 0.23 | 2 |

Listing Codec Concurrent Codec Combination Profiles

Another exemplary solution that meets the above format requirements for the codec capabilities information is to list all the combinations of codec operations that the terminal can handle simultaneously. This may have the advantage that it does not require communicating the processor loading consumed by each codec function. The Table 2 below gives a non-exhaustive list of supported profiles based on the processor loading factors described in the previous section. For example, the processor loading factor may comprise the resource allocation factor described above with respect to Table 1. In aspects, selection of a codec type or data type by a terminal may be based on the processor loading factor or the resource allocation factor.

In some embodiments, two new SDP attributes, a=enc_list and a=dec_list are defined (in augmented backus-naur form (ABNF)) as follows:
enc_list=“a” “=” “enc_list” “:” combination [*63(“;” combination)]
dec_list=“a” “=” “dec_list” “:” combination [*63(“;” combination)]
combination=1*32(num SP codec SP level SP [profile]))
num=% d1-16
codec=byte-string
   ; byte-string defined in RFC 4566
level=1*3DIGITDIGIT
profile=1*3DIGIT

In some aspects, num specifies the maximum number of supported concurrent encoders (for a=enc_list) or decoders (for a=enc_list) of the specified codec at the specified level and profile (when present) in an entry of the list. In some aspects, codec, level and profile have the same semantics as <codec>, <level> and <profile>, respectively, given above in an entry of the list.

Alternatively, a new SDP attribute may be defined in ABNF as follows:
codec_list=“a” “=” “enc_list” “:” function “:” combination [*63(“;” combination)]
function=“ENC”/“DEC”
combination=1*32(num SP codec SP level SP [profile])
num=% d1-16
codec=byte-string
   ; byte-string defined in RFC 4566
level=1*3DIGIT
profile=1*3DIGIT

In some aspects, num specifies the maximum number of supported concurrent encoders (when function=“ENC”) or decoders (when function=“DEC”) of the specified codec at the specified level and profile (when present) in an entry of the list. In some embodiments, codec, level and profile have the same semantics as <codec>, <level> and <profile>, respectively, given above.

In other embodiments, a new SDP attribute may be defined in ABNF as follows:
codec_list=“a” “=” “codec_list” “:” codeclist “:” “ENC:” combination [*63(“;” combination)] “:” “DEC:” combination [*63(“;” combination)]
codeclist=“{” codec SP level SP [profile] “};” *15(“;{” codec SP level SP [profile] “}”)
combination=1*32(num SP codec_idx)
codec=byte-string
   ; byte-string defined in RFC 4566
level=1*3DIGIT
profile=1*3DIGIT
num=% d1-16
codec_idx=% d1-16

In some aspects, codec, level and profile have the same semantics as <codec>, <level> and <profile>, respectively, given above. In some aspects, num specifies the maximum number of supported concurrent encoders (when the combination follows “ENC”) or decoders (when the combination follows “DEC”) of the specified codec at the specified level and profile (when present). In some aspects, codec_idx specifies that the index to the list codeclist of the specified codec at the specified level and profile (when present).

In some embodiments, num may be defined as num=% d0-16. In addition to the description and equations above, a value of 0 specifies that the terminal is capable of picking and trimming data streams. In some aspects, the terminal capable of picking and trimming data streams can handle an infinite number of data streams.

In other embodiments, in the above alternatives with num in the range of 1 to 16, inclusive, one more new SDP attribute is defined as follows:
a=stream_trimming

In some aspects, the presence of this attribute specifies that the terminal is capable of picking and trimming data streams. In some aspects, the terminal capable of picking and trimming data streams can handle an infinite number of data streams. The value of num in a combination still specifies the maximum number of actually supported concurrent encoders or decoders of a particular codec, profile and level. In this case, the terminal can receive any amount of data streams and can trim the data streams to the amount allowed by the a=codec_list attribute for each codec/profile/level combination.

In some aspects, there can be many codec combinations, increasing exponentially as the number of codecs supported increases. This can increase the message size, e.g., SDP/SIP. For example, some reduction in signalling can be made by applying additional rules such as listing the codec functions in order of decreasing complexity. Then, understanding that if the number of instances of a codec function of a higher complexity is reduced by one, an instance of one of the less complex codec functions on the same processor can be increased by at least one. While in some aspects, this may give a less-than-optimal limit when the codec process whose number of instances is reduced is more complex than the others codec processes, it may allow omitting a number of profiles. In some aspects, concurrent operation of the same video codec may be necessary if the terminal needs to generate a thumbnail that is simulcast with a full resolution image.

TABLE 2

| | Encoders | | | | | Decoders | | | | |
|---|---|---|---|---|---|---|---|---|---|---|
| | | | Audio | | | | | Audio | | |
| | Video | | | AMR- | AMR- | Video | | | AMR- | AMR- |
| Profile | H.265 | H.264 | EVS | WB | NB | H.265 | H.264 | EVS | WB | NB |
| Load | 0.8 | 0.6 | 0.5 | 0.2 | 0.08 | 0.2 | 0.15 | 0.1 | 0.04 | 0.02 |
| Factor | | | | | | | | | | |
| A | 1 | | | 1 | 1 | 1 | 4 | | 1 | 4 |
| B | 1 | | | 1 | 1 | 1 | 4 | | 2 | 2 |
| C | 1 | | | 1 | 1 | 1 | 4 | | 3 | |
| D | 1 | | | 1 | 1 | 1 | 1 | | 10 | 8 |
| E | | 1 | 1 | | 1 | 1 | 1 | 3 | 2 | 4 |
| F | | | 1 | 1 | 1 | | | 5 | 12 | 12 |
| G | | 1 | 1 | | 1 | | 2 | 5 | | 1 |
| H | | 1 | 1 | | 1 | 1 | 2 | 3 | | 1 |
| I | | 1 | 1 | | 1 | 1 | 1 | 3 | 2 | 4 |
| . . . | | | | | | | | | | |

Profiles of Supported Concurrent Codec Combinations

The profiles listed in Table 2 may not apply well to use cases that require simulcast of video using the same codec (i.e., low and high resolution images) as only one encoder is supported at a time. This may be a limitation of the processor loading and not the profile scheme itself.

In some embodiments, profiles A through D in Table 2 can be thought of as the “HD Video” profiles that use H.265 at the expense of not allowing use of EVS. Although profiles A through C can handle the decoding of four H.264 streams, they may not be used in typical multi-unicast video conferences because they may only be capable of encoding one video stream. In some aspects, a user of this terminal may wish to only send video to one of the other participants, e.g., a video side bar conversation used for communicating sign language.

Aside from simple 2-party video sessions, profiles A through D may be more applicable to multicasting or “focused-based multicasting” conferences where the H.265 codec is known to be supported by all terminals. Note that Profile C may be considered invalid if AMR-NB is a mandatory codec for the service being offered as AMR-NB decoding is not supported.

In some aspects, profile F can be thought of as the “HD Voice only” profile, to be used in speech-only conferences. Since use cases requiring simultaneous encoding of speech using the same encoder are yet to be identified, the speech-only profiles may only need to consider concurrently operating one instance of each speech encoder. This can simplify the number of profiles that need to be listed for speech-only conferences and profile F appears to be the only relevant speech-only profile as conferences supporting more than 13 participants are unlikely and may very well exceed the RTP stream processing limits of the terminal (described further below).

For terminals that perform trimming or reduction of received media streams without requiring decoding all of them (as further described below), the number of instances of the decoder function can be indicated as “infinity” as follows in Table 3. Table 3 illustrates an exemplary embodiment for a terminal that can trim down to three streams of received audio data:

TABLE 3

| | Encoders | | | | | Decoders | | | | |
|---|---|---|---|---|---|---|---|---|---|---|
| | | | Audio | | | | | Audio | | |
| | Video | | | AMR- | AMR- | Video | | | AMR- | AMR- |
| Profile | H.265 | H.264 | EVS | WB | NB | H.265 | H.264 | EVS | WB | NB |
| Load | 0.8 | 0.6 | 0.5 | 0.2 | 0.08 | 0.2 | 0.15 | 0.1 | 0.04 | 0.02 |
| Factor | | | | | | | | | | |
| A | 1 | | | 1 | 1 | 1 | 4 | | 1 | Inf |
| B | 1 | | | 1 | 1 | 1 | 4 | | 2 | 2 |
| C | 1 | | | 1 | 1 | 1 | 4 | | Inf | 0 |
| D | 1 | | | 1 | 1 | 1 | 1 | | Inf | Inf |
| E | | 1 | 1 | | 1 | 1 | 1 | Inf | 2 | Inf |
| F | | | 1 | 1 | 1 | | | Inf | Inf | Inf |
| G | | 1 | 1 | | 1 | | 2 | Inf | | 1 |
| H | | 1 | 1 | | 1 | 1 | 2 | Inf | | 1 |
| I | | 1 | 1 | | 1 | 1 | 1 | Inf | 2 | Inf |
| . . . | | | | | | | | | | |

As noted above with reference to FIGS. 1-5, a receiving terminal or device (e.g., terminal 110B, terminal/media gateway 450, etc.) can prioritize and ignore particular data streams to reduce the number decoder instances it has to concurrently operate/decode. If a terminal employs such a “trimming” algorithm and is able to limit the number of data streams it has to decode to match its concurrent decoding capabilities, then the terminal does not require the conference initiator to limit the number of participants in the call based on the terminal's decoding capabilities. In this case the terminal can indicate a resource allocation factor of 0 corresponding to such data streams as illustrated in the following example of Table 4:

TABLE 4

| | | Resource | Resource | |
|---|---|---|---|---|
| | | allocation | allocation | |
| Data | | factor for | factor for | |
| Type | Codec Name | encoder | decoder | proc_num |
| Audio | AMR-NB | 0.1 | 0 | 1 |
| Audio | AMR-WB | 0.2 | 0 | 1 |
| Audio | EVS (WB) | 0.24 | 0 | 2 |
| Audio | EVS (SWB) | 0.28 | 0 | 2 |
| Video | AVC/H.264 | 0.6 | 0.15 | 1 |
| Video | HEVC/H.265 | 0.9 | 0.23 | 2 |

RTP Stream Processing Limits

The ability to support the concurrent decoding of many data streams makes it likely that decoding may not be the limiting factor in setting the size of a conference. The number of real-time transport protocol (RTP) data streams that can be handled by the terminal's protocol stack becomes the limiting factor. Therefore it may be beneficial to also communicate this information. Furthermore, two new session-level SDP attributes can be defined to specify the limits on the number of concurrent RTP stacks:
a=rtp_tx_limit<rtp_instances>
a=rtp_rx_limit<rtp_instances>

In some aspects, <rtp_instances> is an integer in the range of 1 to 32, inclusive, that specifies the maximum number of concurrent RTP sessions supported. In some aspects, conference initiator terminal (e.g., terminal 110A of FIGS. 2-5) uses the above information from each participant in the conference to ensure that the proposed conference does not exceed either the codec or RTP processing capabilities of the participants.

At block 615, the initiator terminal may determine whether all of the two or more devices can participate (or continue to participate) in the conference based on the list of codec capabilities (i.e., the constraints described in the previous sections are all met). In some aspects, if the initiator sees no issues it allows the conference to be established as negotiated and stores all the information received in individual profiles for each of the terminals. In other aspects, if the initiator sees an issue, it can attempt to remedy the problem by sending a new message (e.g., SIP Re-INVITE/UPDATE message) with a viable offer (constructed based on all the received concurrent codec capabilities of the participants) to some, or all, of the participants.

In some embodiments, the initiator terminal may send an offer message based on its concurrent codec capabilities and those of other participants for which their concurrent capabilities are known beforehand. After receiving the offer message, each participant's terminal may examine the offer message to determine N and the maximum number of codecs that are offered to determine if it can meet the constraints described in the previous sections. If the terminal can participate, it may respond with a selected codec.

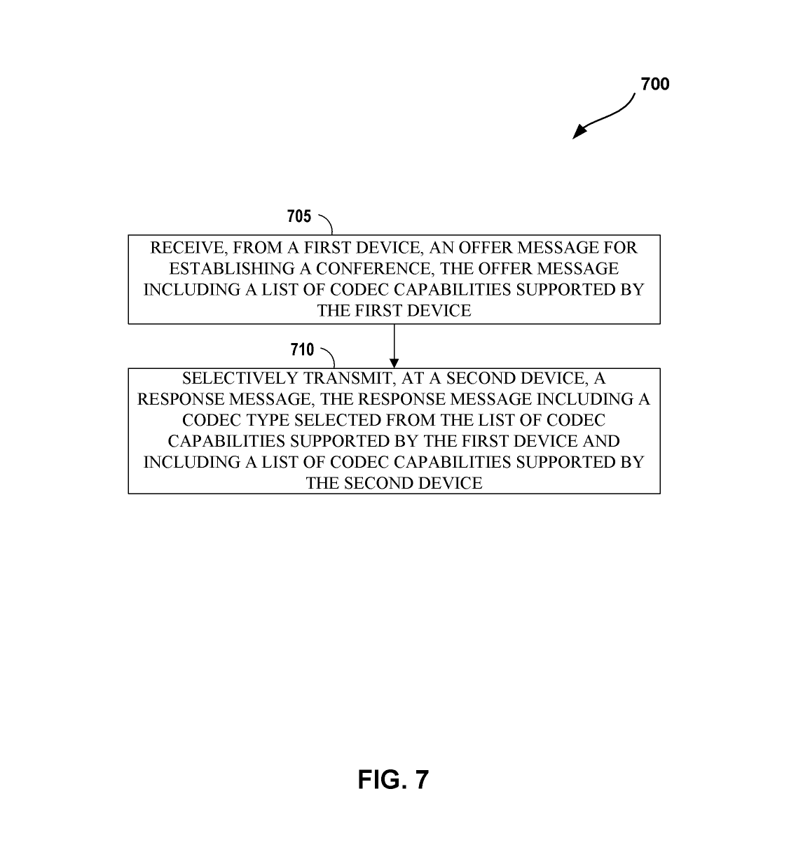

FIG. 7 is a flowchart of an exemplary method 700 of codec negotiation in a decentralized multimedia conference. The method 700 shown in FIG. 7 may be implemented via one or more devices in the conference architecture 200 and/or 300. In some aspects, the method may be implemented by a device similar to the user terminals 110A-D of FIGS. 1-3, or any other suitable device.

At block 705 a terminal (terminal 110B) may receive, from a first device, an offer message for establishing a conference. The offer message may include a list of codec capabilities supported by the first device. In some aspects, the offer message may be based on the initiator terminal's concurrent codec capabilities. In some embodiments, the offer message may also be based on the codec capabilities of the other participants for which their concurrent capabilities are known beforehand (terminals 110B and 110C).

At block 710, the terminal selectively transmits a response message, the response message including a codec type selected from the list of codec capabilities supported by the first device and including a list of codec capabilities supported by the terminal. In some aspects, after receiving the offer message, the terminal may process the offer message to determine the number of participants and the maximum number of codecs that are offered to determine if it can meet the constraints described herein. If the terminal can participate, it may respond with a response message including a selected codec from the list of codec capabilities supported by the first device and a list of its own codec capabilities. If the terminal determines it cannot participate it may not respond with a response message.

In another embodiment, the other participating terminals (e.g., terminals 110B and 110C) can also include their concurrent codec capabilities in the response message. This allows the initiator terminal to store and guarantee that the terminal's capabilities are properly considered for any future conferences initiated by the same initiator terminal. In some aspects, the initiator terminal may store the capabilities in a database.

If the participating terminal determines it cannot participate it indicates this in the response message and sends its concurrent codec capabilities. The initiator terminal may then process the responses from the other participating terminals as follows: (1) if the initiator terminal receives no negative responses it allows the conference to continue; (2) if the initiator terminal receives a negative response then it uses all received concurrent codec capabilities to construct a viable offer message and transmits this in a new message (e.g., SIP Re-INVITE/UPDATE message) to some, or all, of the participants.

In some embodiments, each terminal may store a concurrent codec capabilities profile for each of terminals in its address book or a database. This profile can include the MaxEnc and MaxDec for each data type of each terminal. In other aspects, this profile can include a list of the terminals' codecs for all data types along with resource allocation factor or the percentage of processor complexity used by each instance of the codec. For example, Table 5 below illustrates an exemplary list of the terminals' codecs for all data types along with percentage of processor complexity used by each instance of the codec.

TABLE 5

| Data | | Encoder | Decoder |
|---|---|---|---|
| Type | Codec Name | Complexity | Complexity |
| Audio | AMR-NB | 10% | 2% |
| Audio | AMR-WB | 20% | 4% |
| Audio | EVS | 60% | 20% |
| Video | H.264/AVC | 60% | 15% |
| Video | H.265/HEVC | 90% | 23% |

In some aspects, the initiator terminal can then use the above profile of each of the participants to determine an offer message that can be met by each participant using the constraint considerations described herein.

In communicating their concurrent codec capabilities, terminals can also indicate that they can handle reception of more data streams because they are able to prioritize and ignore data streams of a particular data type. For example, the terminal 110A may indicate that it can concurrently decode up to three EVS data streams (each using 20% of its processor) after which it will ignore any additional data streams received.

In some aspects, terminals can also exchange concurrent codec capabilities information before a conference is initiated to better guarantee that a viable offer message is included in the first initiation messages (e.g., the first SIP INVITE). This exchange of concurrent codec capabilities information can be performed as follows: when a user adds another user to their address book or directory on the terminal, the address book applications contact each other to exchange concurrent codec capabilities as well as any other personal information (home address, etc. . . . ) or when the codec capabilities of a terminal change (via download or swapping of terminal hardware). This exchange of information/profiles could be performed using whatever contact information identifier (ID) is provided between the users. For example: via an embedded profile multipurpose interne mail extensions (MIME) type in an email exchange if the ID is an email address; via an extensible markup language (XML) schema sent over a short message service (SMS) if the ID is the phone number; via an XML schema sent over some other messaging protocol. The profile information can be updated in a variety of ways. For example, the users make a call to each other or via the protocols described earlier for establishing conferences with in-terminal mixing, i.e., concurrent codec capabilities can be sent in the response. In another example, the terminal storing the profile may set a timer to autonomously and periodically (e.g., every month) check back with the other user's terminal to see if the capabilities have changed. These capabilities might change because of a software update or download by the user, or changing their handset. In some aspects, the terminal that has provided a profile may update all the users in its address book whenever its own capabilities have changed. Alternatively, two or more participants in a conference (who are not initiators) can exchange their concurrent codec capabilities when setting up the data session between themselves.

In some aspects, the OPTIONS request can be used to query the codec capabilities of another terminal by asking the terminal to send a copy of the session description protocol (SDP) it would offer describing its codec capabilities. This SDP will contain the concurrent codec capabilities information as described above. The OPTIONS request can be made well in-advance of a conference call and the SDP response may be stored in a profile for the queried terminal. In some embodiments, immediately before setting up a conference, the conference initiator could query the codec capabilities of all the terminals it plans to invite for which it does not have the information pre-stored.

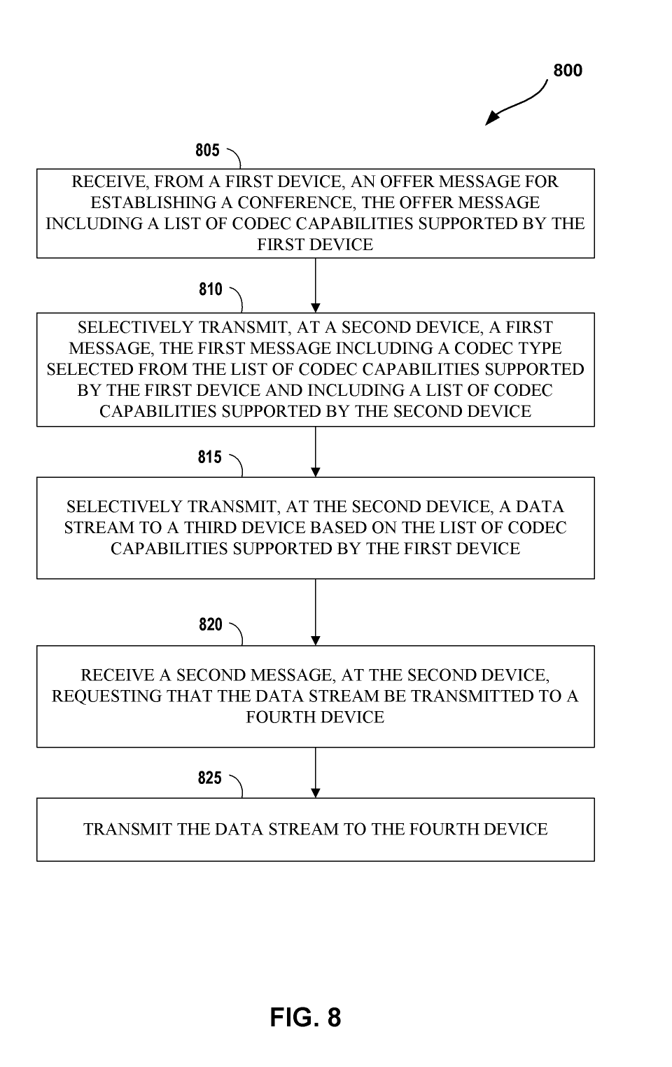

FIG. 8 is a flowchart of an exemplary method 800 of codec negotiation in a multimedia conference. The method 800 shown in FIG. 8 may be implemented via one or more devices in the conference architectures 100, 200, 300, 400, and 500 in FIGS. 1-5. In some aspects, the method 800 may be implemented by a device similar to the user terminals 110A-D, the centralized processor 125, and/or the terminal/media gateway 450 of FIGS. 1-5, or any other suitable device.

At block 805 a terminal (e.g., terminal/media gateway 450 of FIG. 5) may receive, from a first device, an offer message for establishing a conference. The offer message may include a list of codec capabilities supported by the first device.

At block 810, the terminal selectively transmits a first message. The first message may include a codec type selected from the list of codec capabilities supported by the first device and including a list of codec capabilities supported by the second device.

At block 815, the terminal selectively transmits a data stream to a third device based on the list of codec capabilities supported by the first device. At block 820, the terminal receives a second message requesting that the data stream be transmitted to a fourth device. At block 825, the terminal transmits the data stream to the fourth device.

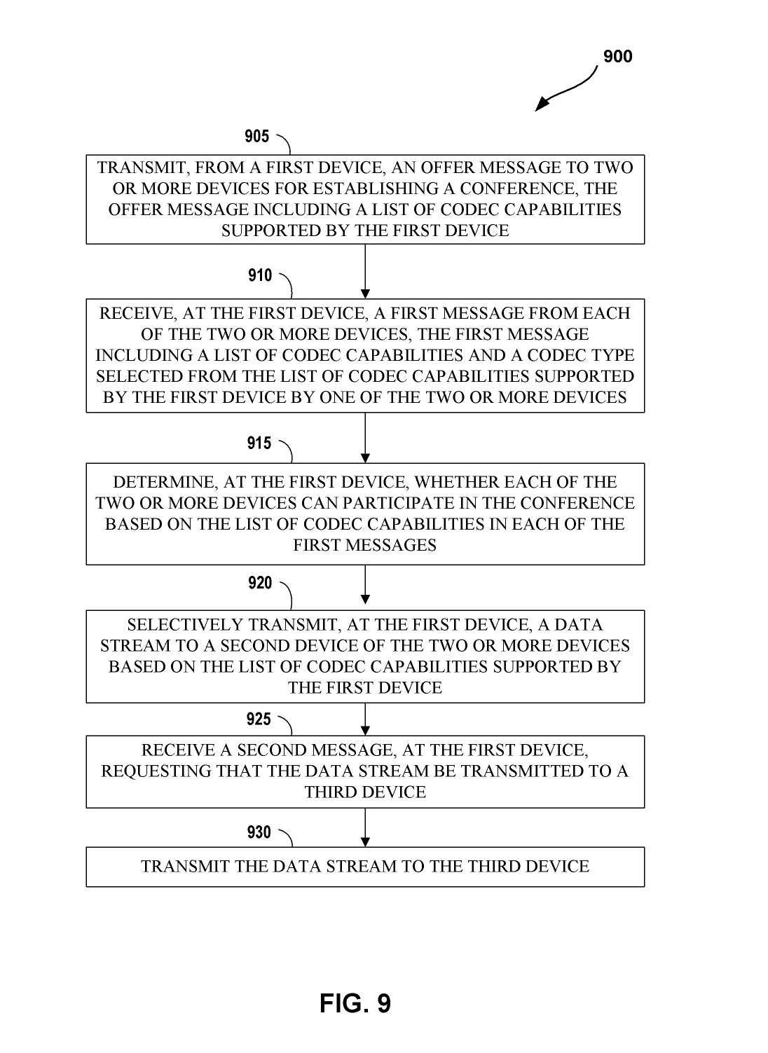

FIG. 9 is a flowchart of an exemplary method 900 of codec negotiation in a multimedia conference. The method 900 shown in FIG. 9 may be implemented via one or more devices in the conference architectures 100, 200, 300, 400, and 500 in FIGS. 1-5. In some aspects, the method 800 may be implemented by a device similar to the user terminals 110A-D, the centralized processor 125, and/or the terminal/media gateway 450 of FIGS. 1-5, or any other suitable device.

At block 905 a terminal (e.g., terminal 110A of FIG. 5) may transmit an offer message to two or more devices for establishing a conference. The offer message may include a list of codec capabilities supported by the terminal.

At block 910, the terminal receives a first message from each of the two or more devices, the first message including a list of codec capabilities and a codec type selected from the list of codec capabilities supported by the first device by one of the two or more devices. In some aspects, the list of codec capabilities in the first message comprises a list of codec capabilities supported by a device of the two or more devices transmitting the first message.

At block 915, the terminal determines whether each of the two or more devices can participate in the conference based on the list of codec capabilities in each of the first messages. At block 920, the terminal selectively transmits a data stream to a second device of the two or more devices based on the list of codec capabilities supported by the first device. At block 925, the terminal receives a second message requesting that the data stream be transmitted to a third device. At block 930, the terminal transmits the data stream to the third device.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. For example, means for transmitting an offer message to two or more devices may comprise a transmitter or an antenna of the terminals 110A-D. Additionally, means for receiving a response message may comprise a receiver or an antenna of the terminals 110A-D. Additionally, means for determining whether the two or more devices may continue to participate in the conference may comprise a processor of the user terminals 110A-D. Further, means for receiving an offer message from a device may comprise a receiver or an antenna of the terminals 110A-D. Also, means for transmitting a response message may comprise a transmitter or an antenna of the terminals 110A-D.

Information and signals may be represented using any of a variety of different technologies and techniques. For example, data, instructions, commands, information, signals, bits, symbols, and chips that may be referenced throughout the above description may be represented by voltages, currents, magnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for codec negotiation in a conference, the method comprising:
retrieving a list of codec capabilities supported by each of two or more devices in the conference; and
determining, at a first device, whether each of the two or more devices can participate in the conference based on the list of codec capabilities.

2. The method of claim 1, wherein retrieving the list of codec capabilities comprises:
transmitting, from the first device, a request message to the two or more devices for establishing the conference, the request message requesting a list of codec capabilities supported by one of the two or more devices; and
receiving, at the first device, a response message from each of the two or more devices, the response message including a list of codec capabilities supported by one of the two or more devices.

3. The method of claim 1, wherein retrieving the list of codec capabilities comprises retrieving the list of codec capabilities from a database.

4. The method of claim 1, further comprising transmitting, from the first device, an offer message to the two or more devices for establishing the conference, the offer message including a list of codec capabilities supported by the conference.

5. The method of claim 4, wherein the list of codec capabilities supported by the conference is based on the list of codec capabilities supported by each of two or more devices.

6. The method of claim 2, further comprising determining, at the first device, whether each of the two or more devices can participate in the conference based on the list of codec capabilities in each of the response messages.

7. The method of claim 6, wherein the list of codec capabilities in the response message includes a profile of codec operations that can be run concurrently.

8. The method of claim 7, wherein the profile comprises a loading factor.

9. The method of claim 7, further comprising selecting, at the first device, a codec type for communication to each of the two or more devices based on the profile.

10. The method of claim 4, further comprising
receiving, at the first device, a response message from each of the two or more devices, the response message including a list of codec capabilities supported by one of the two or more devices; and
transmitting, from the first device, a second offer message based on the the list of codec capabilities in each of the response messages when the first device determines a device of the two or more devices cannot continue to participate in the conference.

11. The method of claim 1, further comprising storing the list of codec capabilities supported by each of the two or more devices in a database.

12. The method of claim 6, further comprising prioritizing a data stream based on a parameter of the data stream.

13. The method of claim 12, wherein the parameter comprises one or more of a volume level, a complexity level, an activity level, a device or data stream identification (ID) and a data packet size.

14. The method of claim 6, wherein the list of codec capabilities supported by one of the two or more devices comprises a list of codec capabilities supported by a device receiving the request message.

15. The method of claim 1, further comprising:
receiving, at the first device, a request message for establishing a conference, the request message requesting a list of codec capabilities supported by the first device; and
selectively transmitting, at the first device, a response message, the response message including the list of codec capabilities supported by the first device.

16. The method of claim 15, wherein selectively transmitting comprises:
determining a number of devices participating in the conference and a maximum number of codecs offered; and
transmitting the response message based on the number of devices and the maximum number of codecs offered.

17. The method of claim 15, further comprising storing in a database of the first device the list of codec capabilities supported by each device in the conference.

18. A method for codec negotiation in a conference, the method comprising:
receiving, from a first device, an offer message for establishing a conference, the offer message including a list of codec capabilities for the conference; and
selectively transmitting, at a second device, a first message, the first message including a codec type selected from the list of codec capabilities for the conference.

19. The method of claim 18, further comprising:
receiving, at the second device, a first data stream from the first device and a second data stream from a third device;
processing, at the second device, the first and second data streams; and
selectively transmitting, at the second device, a mixed data stream based on the first and second data stream.

20. The method of claim 19, further comprising:
receiving a second message, at the second device, requesting that the processing of the first and second data streams be transferred to a fourth device; and
transmitting a third message, at the second device, indicating the transfer to the fourth device.

21. The method of claim 19, wherein receiving the offer message and selectively transmitting the first message comprises receiving the offer message and selectively transmitting the first message during a first duration, and wherein receiving the first and data streams, processing the first and second data streams, and selectively transmitting the mixed data stream comprises receiving the first and data streams, processing the first and second data streams, and selectively transmitting the mixed data stream during a second duration.

22. The method of claim 19, wherein selectively transmitting the mixed data stream comprises transmitting the mixed data stream based on the list of codec capabilities for the conference.

23. The method of claim 19, wherein selectively transmitting the first message comprises transmitting the first message in response to the offer message or a poll message received at the second device.

24. The method of claim 18 further comprising:
selectively transmitting, at the second device, a data stream to a third device based on the list of codec capabilities for the conference;
receiving a second message, at the second device, requesting that the data stream be transmitted to a fourth device; and
transmitting the data stream to the fourth device.

25. The method of claim 24, wherein the list of codec capabilities in the first message includes a profile of codec operations that can be run concurrently.

26. The method of claim 25, further comprising selecting, at the first device, a codec type for communication to each of the two or more devices based on the profile.

27. The method of claim 24, wherein the list of codec capabilities in the offer message includes a profile of codec operations that can be run concurrently.

28. The method of claim 27, wherein the codec type selected is based on the profile.

29. A method for codec negotiation in a conference, the method comprising:
transmitting, from a first device, an offer message to two or more devices for establishing a conference, the offer message including a list of codec capabilities for the conference;
receiving, at the first device, a first message from each of the two or more devices, the first message including a codec type selected from the list of codec capabilities for the conference;
determining, at the first device, whether each of the two or more devices can participate in the conference based on the list of codec capabilities for the conference;
selectively transmitting, at the first device, a data stream to a second device of the two or more devices based on the list of codec capabilities for the conference;
receiving a second message, at the first device, requesting that the data stream be transmitted to a third device; and
transmitting the data stream to the third device.

30. An apparatus for communicating in a conference, the apparatus comprising:
a receiver configured to receive a request message for establishing the conference, the request message requesting a list of codec capabilities supported by the apparatus; and
a transmitter configured to selectively transmit a response message, the response message including a list of codec capabilities supported by the apparatus.
